(19) United States
(12) Patent Application Publication
(10) Pub. No.: US 2018/0179809 A1
(43) Pub. Date: Jun. 28, 2018

(54) WINDOW INSULATING FILM ROLL, KIT AND METHOD OF INSTALLATION

(71) Applicant: RCR INTERNATIONAL INC., Boucherville (CA)

(72) Inventors: David MATHIEU, Glastonbury, CT (US); Jim SENER, Glastonbury, CT (US); Andrew REED, Glastonbury, CT (US)

(21) Appl. No.: 15/822,008

(22) Filed: Nov. 24, 2017

Related U.S. Application Data
(60) Provisional application No. 62/426,289, filed on Nov. 24, 2016.
(60) Provisional application No. 62/517,577, filed on Jun. 9, 2017.
(60) Provisional application No. 62/529,821, filed on Jul. 7, 2017.

(51) Int. Cl. E06B 7/23; E06B 3/28

(52) U.S. Cl. CPC E06B 7/2301; E04B 1/66; E06B 3/285; E06B 7/2314

(57) ABSTRACT

A window insulating film roll and kit for insulating windows or a sheet such as a bug screen for covering other types of dwellings. The window insulating film of translucent or transparent polymer has a pair of longitudinal edges and a pair of lateral edges transverse to the longitudinal edges, a strip of adhesive along one of the longitudinal edges, a releasable backing strip covering the strip of adhesive. The window insulating film is rolled about an axis generally parallel to the longitudinal edges starting with the longitudinal edge away from the backing strip to form an elongated film roll, the elongated film roll being rolled about an axis generally transverse to the longitudinal edges to form a window insulating film roll, A dispenser has a receptacle for rollingly receiving the window insulating film roll, a dispensing outlet being defined in a wall of the receptacle for a free end of the window insulating film roll to pass therethrough during dispensing.

### CROSS-REFERENCE TO RELATED APPLICATION

The present application claims the priority of U.S. Patent Application No. 62/426,289, filed on Nov. 24, 2016, of U.S. Patent Application No. 62/517,577, filed on Jun. 9, 2017, and of U.S. Patent Application No. 62/529,821, filed on Jul. 7, 2017, all of which are incorporated herein by reference.

### TECHNICAL FIELD

The present application relates to window insulating films used for weather proofing.

### BACKGROUND OF THE ART

In colder climates, windows may be responsible for substantial energy losses. Indeed, windows often have a lower insulating value that surrounding walls. Moreover, as windows are commonly openable and closable, a path may be formed for drafts. Therefore, insulating film kits have been made available so as to form air spaces inside or outside of a window. Due to the insulating nature of air, such air spaces can substantially increase the insulating factor of a window and provide other benefits, such as protecting against drafts and preventing frost and condensation. However, there is a need to facilitate the installation of such insulating films on windows.

### SUMMARY

It is an aim of the present disclosure to provide a window insulating film roll that addresses issues associated with the prior art.

It is a further aim of the present disclosure to provide a window insulating film kit that addresses issues associated with the prior art.

It is a still further aim of the present disclosure to provide a method for installing a window insulating film that addresses installation issues associated with the prior art.

According to a first embodiment, there is provided an insulating film or sheet roll comprising a film or sheet having a pair of longitudinal edges and a pair of lateral edges transverse to the longitudinal edges, an elongated connector extending along one of the longitudinal edges, the insulating film or sheet being rolled about an axis generally parallel to the longitudinal edges starting with the longitudinal edge away from the elongated connector to form an elongated film or sheet, the elongated film or sheet roll being rolled about an axis generally transverse to the longitudinal edges to form the insulating film or sheet roll.

According to another embodiment, there is provided an insulating film or sheet kit comprising: an insulating film or sheet roll comprising a film or sheet having a pair of longitudinal edges and a pair of lateral edges transverse to the longitudinal edges, an elongated connector extending along one of the longitudinal edges, the insulating film or sheet being rolled about an axis generally parallel to the longitudinal edges starting with the longitudinal edge away from the elongated connector to form an elongated film or sheet, the elongated film or sheet roll being rolled about an axis generally transverse to the longitudinal edges to form the insulating film or sheet roll, and a dispenser having a receptacle for rollingly receiving the insulating film or sheet roll, a dispensing outlet being defined in a wall of the receptacle for a free end of the insulating film or sheet roll to pass therethrough during dispensing.

According to another embodiment, there is provided a method for installing insulating film on a window structure, comprising: forming an open-ended double-sided tape continuous contour on the window structure; selecting a length of rolled insulating film corresponding to a distance of an open end of the double-sided tape continuous contour; removing a backing strip from the length of the rolled insulating film to expose an adhesive strip of the rolled insulating film; adhering the adhesive strip of the rolled insulating film to the window structure with the adhesive strip closing the open end of the double-sided tape continuous contour; unrolling the rolled insulating film; and adhering the insulating film to the double-sided tape continuous contour.

### DESCRIPTION OF THE DRAWINGS

FIG. 1 is a schematic perspective view of a window insulating film in accordance with the present disclosure;

FIG. 2 is an enlarged view showing the rolling of the window insulating film on a core;

FIG. 3 is an end view of the window insulating film on the core;

FIG. 4 is a schematic view of a window insulating film roll in accordance with the present disclosure;

FIG. 5 is a perspective view of the window insulating film kit in accordance with the present disclosure, with the window insulating film roll of FIG. 4 as installed in a dispenser along with a tape roll;

FIG. 6 is a perspective view showing the window insulating film kit;

FIG. 7 is a perspective view of window insulating film being dispensed from the dispenser;

FIGS. 8A to 8E are sequential views showing the installation of the window insulating film on a window casing in accordance with the present disclosure;

FIG. 9 is a perspective view of a frame member and cap of a window insulating kit of the present disclosure, for window frame interior mount;

FIG. 10 is a perspective view showing the frame member of FIG. 9 as mounted to a window frame interior;

FIG. 11 is a perspective view of a window insulating kit featuring the frame member of FIG. 9 as mounted to the window frame interior;

FIG. 12 is a perspective view of a frame member and cap of a window insulating kit of the present disclosure, for window frame exterior mount;

FIG. 13 is a perspective view showing the frame member of FIG. 12 as mounted to a window frame exterior, in an exterior mount; and

FIG. 14 is a perspective view of a window insulating kit featuring the frame member of FIG. 12 as mounted to the window frame exterior.

### DETAILED DESCRIPTION

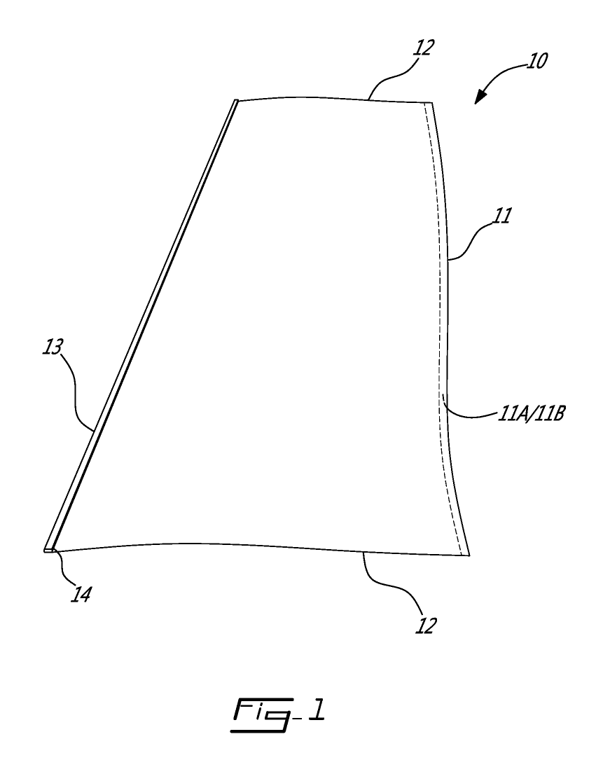

Referring to the drawings are more particularly to FIG. 1, an insulating film is generally shown at 10. The insulating film is made of a generally air-tight transparent polymer. The insulating film 10 may have different properties, including that of being as clear and colourless as possible, although it is possible to have colour and/or tint added to the film. Another contemplated characteristic is its elasticity. Yet another possible characteristic is its capability of shrinking when heated (i.e., shrink wrap). Various materials may be used for the insulating film 10, including vinyl, polyolefin, PVC, polyethylene, polypropylene, to give a few examples of many possible polymers that may be used to form the insulating film 10. The insulating film 10 may also have UV protection additives or subfilm, or reflective features for summer use. As another possible embodiment, the film 10 has ornamental features of text and images, such as seasonal themes (e.g., Season's Greetings). Moreover, while the expression film is used throughout, the present disclosure may apply to other types of sheets, i.e., not necessarily insulating films, such as screens (bug screens), etc. Also, while the description refers to windows, the film 10 or other sheet may be applied to other dwelling openings, such as door, for example. Nonetheless, for simplicity, reference is made herein to window insulating film, or insulating film, for a consistency with figures, but it is clear that the description below extends to other sheets for other dwelling openings as well.

As shown in FIG. 1, the insulating film 10 has a top edge 11. The expression “top edge” is used as this edge will be the one superposed on a head of a window casing, as explained hereinafter in the steps of installation. However, it would also be possible to install the film with the edge 11 being on either one of the jambs or on the sill, although the installation method may be simplified by installing the top edge 11 on the head of the window casing. Hence, the expression “top” edge will be used throughout as reference to a suggested installation orientation of the insulating film 11, yet the top edge 11 may also be a side edge or a bottom edge depending on the contemplated use. An orientation of designs or ornamental features could be oriented as a function of the top edge 11. The top edge 11 has a strip of adhesive 11A along its edge. The strip of adhesive 11A extends the full length of the top edge 11 and is continuous and uninterrupted along the top edge 11. A backing strip 11B (FIG. 8B) may be provided and overlaid on the adhesive strip 11A to temporarily cover the adhesive 11A and facilitate the manipulation of the film 10 via its top edge 11. The backing strip 11B may be readily removed by a simple pull. The backing strip 11B may also be known as a liner, and may for example be a waxed paper. It is also contemplated to provide an adhesive-release layer between the adhesive 11A and the backing strip 11B. Either or both of the adhesive 11A and backing strip 11B may have a scale or distance markings to indicate a length of a strip of film 10 being dispensed. As another embodiment, the top edge 11 has a cord 11A (e.g., rubber cord, resilient cord, elastomeric cord, bubble, hollow sealing strip) instead of an adhesive and backing strip 11B. As yet another embodiment, the top edge 11 has a cord 11A, the adhesive 11A and the backing strip 11B. The use of the film 10 with the cord 11A is described hereinafter, with reference to FIGS. 9 to 16. As yet another embodiment, the insulating film 10 may in fact be a pair of superposed sheets interconnected at the top edge 11, and with cord 11A and/or adhesive 11A and backing strip 11B. Concurrently, or separately, the cord 11A and/or adhesive 11A and backing strip 11B can be referred to as elongated connector. The underlying sheet may be for example the insulating film 10 or screen while the other is a curtain, or a decorative sheet, etc.

Lateral edges 12 are transverse (e.g., perpendicular) relative to the top edge 11, whereas a core edge 13 is opposite the lateral edge 12, and generally parallel to it. As the insulating film 10 is provided in sufficient length to insulate numerous windows, there may be a substantially greater length of film (i.e., the top edge 11) than height (lateral edges 12). In other words, the longitudinal edges 11 and 13 are substantially longer than the lateral edges 12, for example in a ratio of at least 3:1. A light adhesive or tape may be provided at the core edge 13 so as to facilitate its securement to a core 14. For example, the core 14 may be a cardboard core. Alternatively, other materials such as paper or some polymers could be used as well, provided they are flexible enough to be rolled. According to an embodiment, the core 14 is tubular and has rounded edges so as to reduce the possibility of film creasing when rolled onto the cardboard core 14. Other configurations for the core 14 include a cardboard or plastic strip, a rope, etc. The core 14 may even be a portion of the film 10 rolled on itself to form a string or substrate. The film 10 may also be rolled without the core 14.

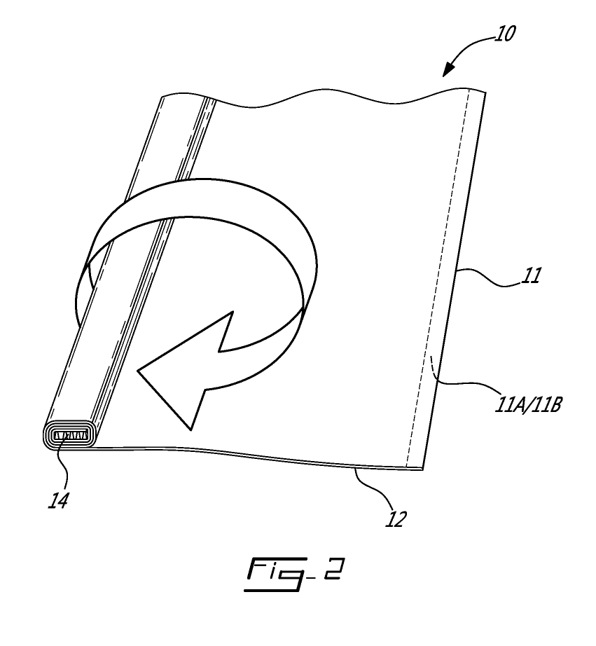

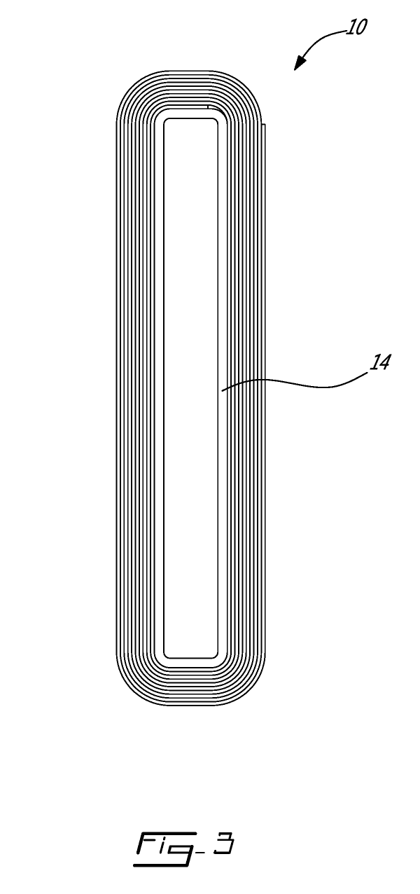

Referring to FIG. 2, it is shown that the film 10 is rolled onto the core 14 so as to define an elongated roll, shown from an end view in FIG. 3 (although it may be rolled on itself as well). The rolling is along an axis generally parallel to the top edge 11. According to an embodiment, the adhesive 11A and the backing 11B or cord 11A are on the opposite side of the core 14, although the other way around would be possible as well. There results an elongated roll, upon which the film 10 is rolled, overlaid or folded.

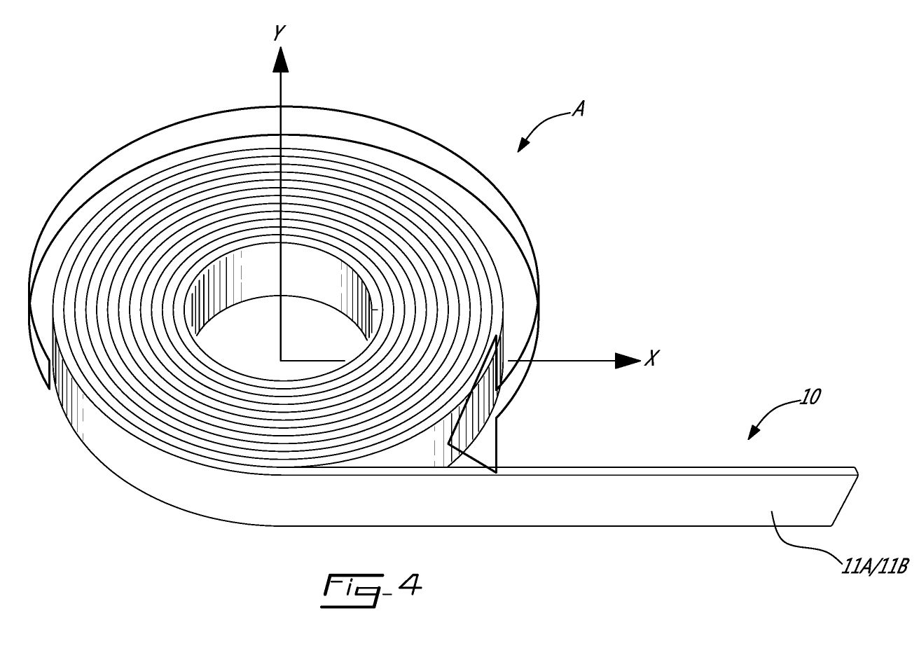

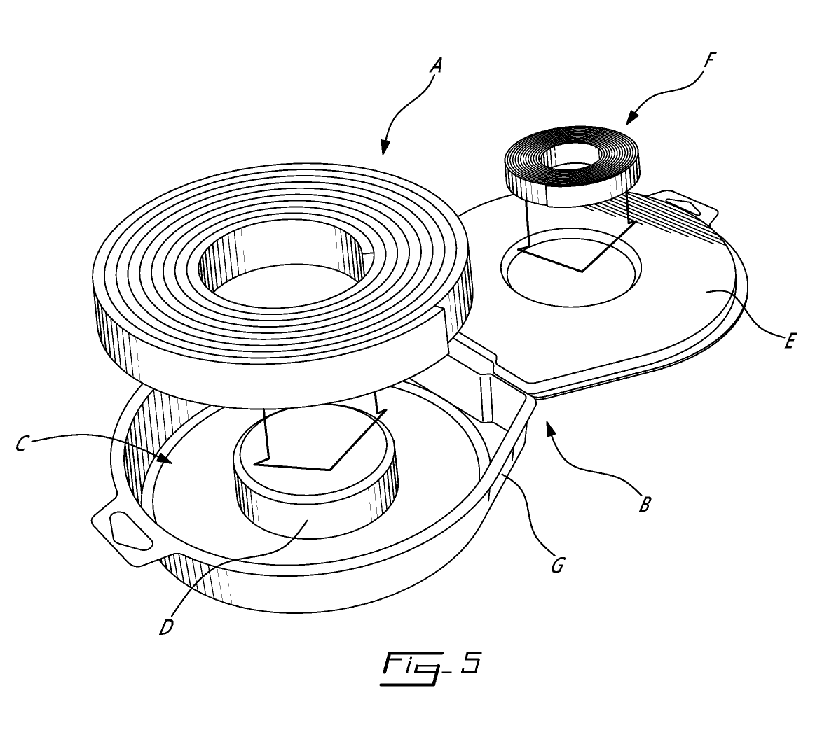

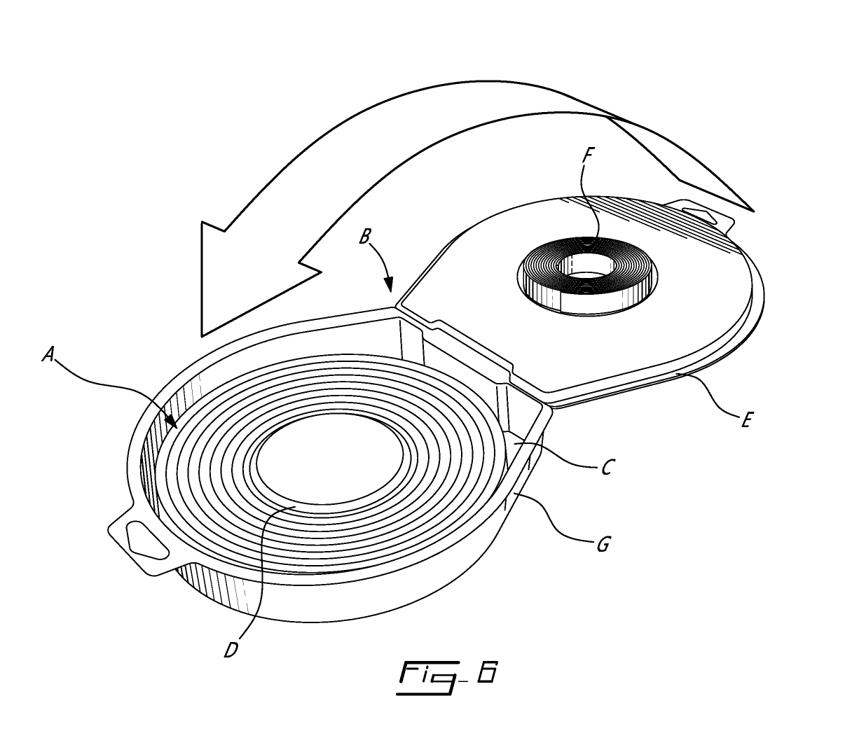

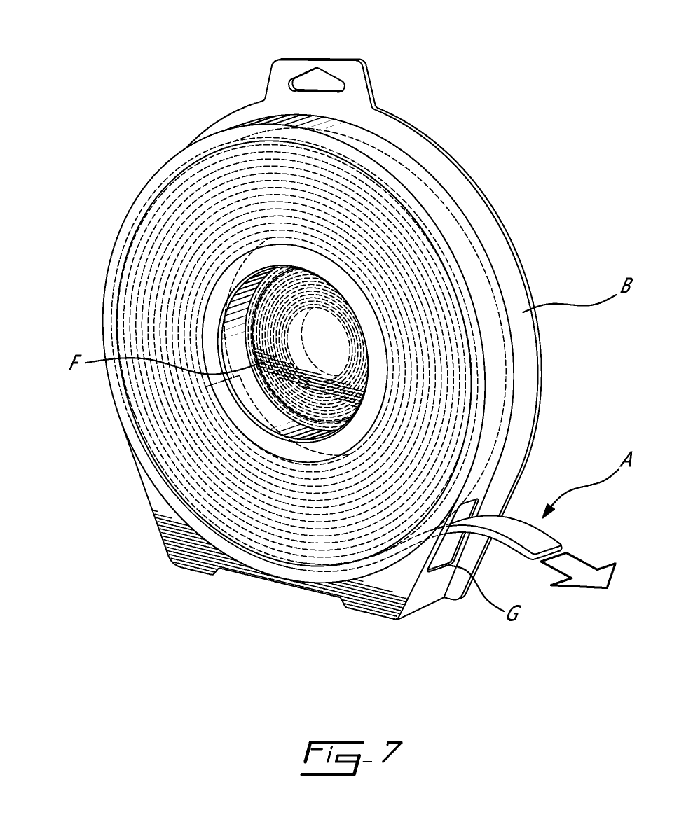

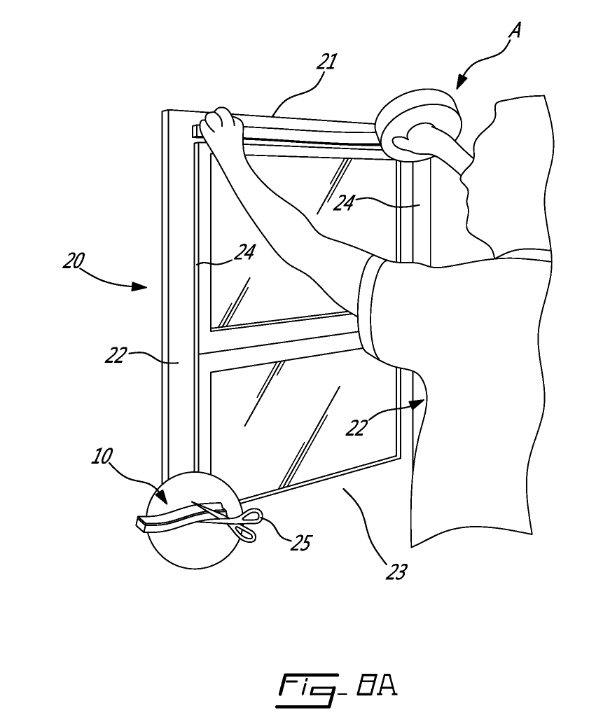

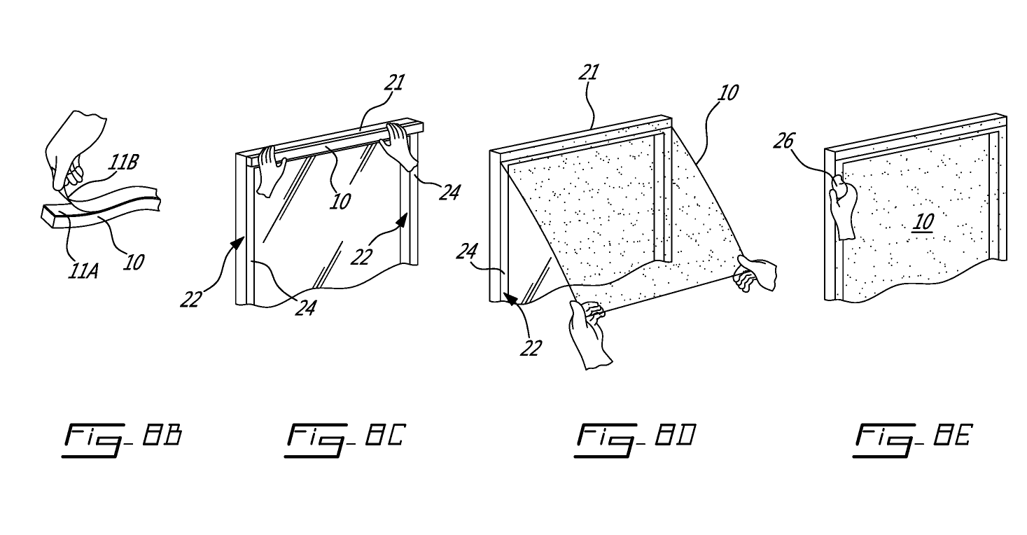

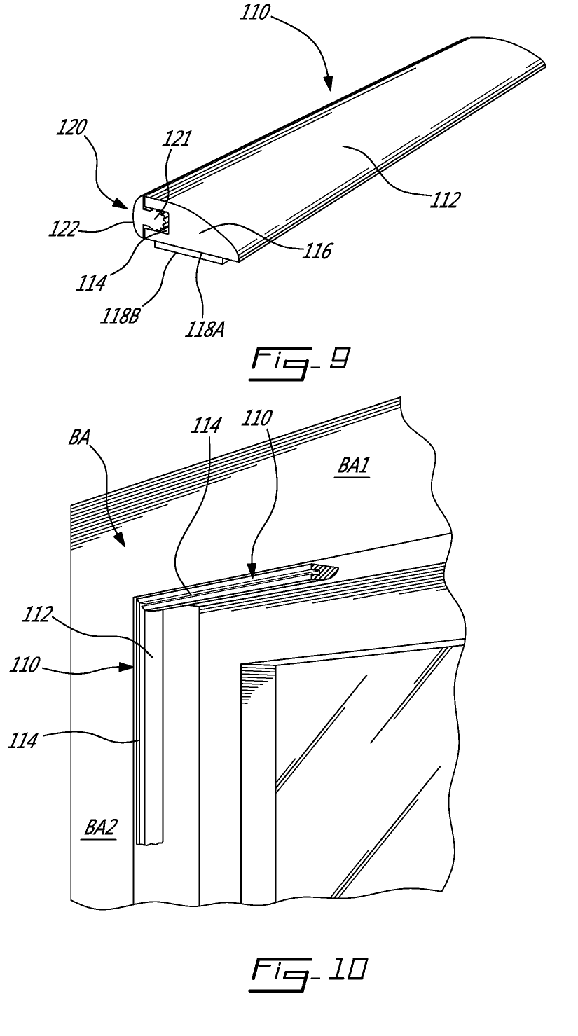

Due to the flexible nature of the film 10 and of the core 14, it is then possible to form a film roll A in the manner shown in FIG. 4. The window insulating film roll A is formed by simply rolling the film 10 along its longitudinal direction, about an axis generally transverse to the longitudinal edges 11 and 13. The film roll A is essentially a spiral of rolled film 10, with a free end from which a length of film 10 may be obtained. The film roll A may be rolled in the manner shown in FIG. 4 is such a way that the adhesive 11A and backing strip 11B face away from the center of the roll A. The roll A may be in the form of a disk or in the form of a ring. Although not shown, a core cylinder (e.g., cardboard, chipboard) could be used so as to mount the roll of film 10 thereon. There results the window insulating film roll A in accordance with the present disclosure that may be used according to a method of installation shown in FIGS. 8A-8E and described below. The window insulating film roll A has the window insulating film 10 of transparent polymer with a pair of longitudinal edges 11 and 13 and a pair of lateral edges 12 transverse to the longitudinal edges 11 and 13. A strip of adhesive 11A and/or cord 11A is provided along the longitudinal edge 11, and a releasable backing strip 11B covers the strip of adhesive 11A. The window insulating film 10 is rolled about an axis X generally parallel to the longitudinal edges starting with the longitudinal edge 13 away from the backing strip 11B to form an elongated film roll as in FIG. 3, the elongated film roll being rolled about an axis Y generally transverse to the longitudinal edges 11 and 13 to form the window insulating film roll A.

According to an embodiment, a dispenser B may be provided to facilitate the dispensing of a length of rolled film 10 from the film roll A, as part of a window insulating film kit. The dispenser B may have a receptacle body forming an inner annular cavity C with a hub D, although the cavity may be other shapes (square-section prism) and the hub is not necessarily present. A cover E may be pivotally mounted to a base of the dispenser B so as to hold the film roll A captive therein. The hub D may be hollow so as to form a second receptacle for receiving a tape roll F therein. A diameter of the hub D is selected so as to ensure the proper rotation of the rolled film 10 thereon. As observed in FIGS. 5, 6 and 7, a dispensing outlet G is defined through a wall of the receptacle body for the free end of the film roll A to be dispensed from the dispenser B. The dispensing outlet G is arranged such that the free end of the film roll A exits generally tangentially to a remainder of the film roll A. Once the film roll A and, optionally, the tape roll F are inside the dispenser B, the cover E may be pivoted closed in the manner shown in FIG. 7, at which point the film roll A may roll around the hub D so as to be dispensed via the outlet G into a selected length. Other configurations of the dispenser B are also considered. For example, the dispenser B may be without a hub D if the roll A is a disk instead of a ring. For example, the dispenser B may be constituted of two receptacle bodies concurrently forming the inner annular cavity C instead of a single receptacle body. Moreover, the window insulating film kit may be with or without the tape roll F. The dispenser B may be reusable, with the window insulating film roll A of FIG. 4 and the tape roll F (if applicable) being sold as refills. While the dispenser B is shown as being a see-though molded component, the dispenser B may be an appropriately sized cardboard or fiber-based casing with dispensing outlet G arranged for the tangential exit of an end of the film roll A.

Now that the window insulating film roll A and dispenser B have been described, the installation of the insulating film 10 on a window casing is described with reference to FIGS. 8A to 8E.

In FIG. 8A, for context, the window casing is generally shown at 20 and is the structure that surrounds the window. The window casing may also be known as window frame, window structure, etc. The window casing 20 has a head 21, jambs 22 on opposed sides and a sill 23 at a bottom. The insulating film 10 will be installed about a peripheral contour of the window casing 20, although it is possible to install the insulating film 10 on other parts of the window or window casing. For example, a window structure may be integrally part of the window and may be the structure to which the insulating film 10 is installed. It is also possible to install the insulating film 10 on the inside or the outside of the window.

According to a FIG. 8A, strips 24 of double-sided tape are installed along the jambs 22 and sill 23. The strips 24 of double-sided tape along the jambs 22 intersect the strip 24 along the sill 23 so as to have a continuous U-shaped frame of double-sided tape, upon which the insulating film 10 will be adhered. Still according to FIG. 8A, a length of the film roll 10 is unrolled from the film roll A, whether it be with or without the use of a dispenser B. Sufficient length of film roll A is obtained to extend between the strips 24 on the jambs 22, such that there is sufficient film 10 to cover the window. Once a sufficient length of rolled film 10 is unrolled from the roll A, the film 10 may be cut off from the roll A at the selected. As illustrated in FIG. 8A, scissors 25 may be used to cut through the rolled film 10 and core 14.

The length of rolled film 10 may then be installed. As shown in FIG. 8B, the backing layer 11B may be removed. This step is facilitated considering that the top edge 11 of the film 10 is exposed in the manner it has been rolled, as shown in FIG. 2. The backing layer 11B may be removed bit by bit or as a whole, so as to expose the adhesive strip 11A and enable the gluing of the top edge 11 of the air-tight film 10 along the head 21 of the window casing 20. In the selected length of rolled film 10 cut off from the roll A, there is a sufficiently long piece of film 10 for the top edge 11 to extend between the strips 24 on the jambs 22.

According to FIG. 8C, the top edge 11 is adhered along the head 21 by action of its adhesive strip 11A. Manual pressure may be applied along the top edge 11 to ensure a proper bond. According to FIG. 8D, the film 10 may be unrolled in a direction opposite that shown in FIG. 2. As a suitable length has been cut off the roll A, the film 10 is wide enough to be applied against the strips 24 on the jambs 22. Again, manual pressure may be applied along the lateral edges 12 to ensure a proper bond, and a padded sliding tool 26 may be used to apply a uniform pressure and avoid tearing the extended film 10.

There may be an excess of film 10 at the bottom, with film 10 exceeding beyond the strip 24 at the sill 23. Accordingly, the excess film may be cut off. If the film is shrink film, it may then be heated to form a creaseless and unobtrusive insulating layer defining an air space.

Stated differently, the method for installing the insulating film 10 on a window structure 20 may comprise: forming an open-ended double-sided tape continuous contour on the window structure 20; selecting a length of rolled insulating film A corresponding to a distance of an open end of the double-sided tape continuous contour; removing a backing strip 11B from the length of the rolled insulating film 10 to expose an adhesive strip 11A of the rolled insulating film; adhering the adhesive strip 11A of the rolled insulating film to the window structure 20 with the adhesive strip 11A closing the open end of the double-sided tape continuous contour; unrolling the rolled insulating film 10; and adhering the insulating film 10 to the double-sided tape continuous contour.

Referring to the drawings and more particularly to FIGS. 9 to 11, there are shown parts of a window insulating kit in accordance with the present disclosure, that may be used with the insulating film 10 having a cord 11A at the top edge 11 as described above. The window insulating kit of FIGS. 8 to 11 has a frame member 110, a cap 120 and film 130 (FIG. 11):
The frame member 110 is used to form a frame or support interfacing the film 130 to a window frame, in an insulating arrangement. The frame formed of segments of the frame member 110 may be left permanently on the window frame for repeated use.
The cap 120 interacts with the frame member 110 in order to retain the film 130 in a taut condition in the manner shown in FIG. 11. As an alternative to a cap 120, the window insulating kit 10 may be provided with a length of cord to be cut to an appropriate length.
The film 130 is the insulating film forming a generally air-tight barrier that will form an air pocket acting as an insulator, and reducing air infiltration through the window. The insulating film made of a generally air-tight transparent polymer. The insulating film 110 may have different properties, including that of being as clear and colourless as possible, although it is possible to have colour and/or tint added to the film, including a UV resistant coating or layer. Another contemplated characteristic is its elasticity. Yet another possible characteristic is its capability of shrinking when heated (i.e., shrink wrap). Various materials may be used for the insulating film 110, including vinyl, polyolefin, PVC, polyethylene, polypropylene, to give a few examples of many possible polymers that may be used to form the insulating film 110. Stated differently, the film 130 may be as any of the embodiments described above for the film 10, including a bug screen, etc.

In FIGS. 10 and 11, for context, the window frame is generally shown at BA and is the structure that surrounds the window. The window frame may also be known as window casing, window structure, etc. The window frame BA has a head BA1, jambs BA2 on opposed sides and a sill at a bottom. The insulating film 130 will be installed about a peripheral contour of the window frame BA, although it is possible to install the insulating film 130 on other parts of the window or window casing. For example, a window structure may be integrally part of the window and may be the structure to which the insulating film 130 is installed. It is also possible to install the insulating film 130 on the inside or the outside of the window.

Referring to FIG. 9, the frame member 110 has an elongated trim body 112, although other expressions may describe the trim body 112, such as elongated member, extrusion, extruded member, etc. The elongated trim body 112 is typically an extrusion, although other methods of fabrication are considered, including a pultrusion. The elongated trim body 112 is typically made of a plastic or a metal. However, the frame member 110 may be available to a user in an indefinite length, and the user of the window insulating kit may be required to cut off segments of the frame member 110. Therefore, the material for the frame member 110 must allow the cutting off of sections in such a way that clean joints are made, for making right-angle assemblies of end-to-end segments of the frame member 110, after 45 degree cuts, for example. The material selected for the frame member 110 may be influenced by the contemplated ease of sectioning parts of the frame member 110. As an example, the frame member 110 may be cutable by scissors. The frame member 110 may also have sufficient resilience to come as a roll, in such a way that the frame member 110 is rolled in elastic deformation, to then be straightened for use.

The elongated trim body 112 has a longitudinal cavity 114 extending along its full length. The longitudinal cavity 114 may have any appropriate cross-section, including a relatively rectangular shape. As shown in FIG. 9, one of the end faces 116 illustrates one possible cross-sectional shape of the elongated trim body 112. The illustrated cross-section is that of a right-angle triangle with a curved hypotenuse, and is well suited to provide a minimalistic look. Other shapes include a rectangular cross-section, a triangular cross-section, among many numerous possibilities. In all possible shapes, the elongated trim body 112 has the longitudinal cavity 114 that forms a concavity in the cross-sectional shape as observed from the end face 116 of FIG. 9. The longitudinal cavity 114 is devised to receive the cap 120 in a male/female arrangement, with the cap 120 received in the longitudinal cavity 114, or the cord 11A of the film 10, as in FIG. 1. However, the opposite arrangement is possible as well, with the cap 120 acting as female for connection with the trim body 112, in which case the trim body 112 would have a projecting member or portion.

An adhesive 118A may be provided on a contact surface of the elongated trim body 112. The contact surface is generally flat as it will be applied against a flat surface of the window frame A. The adhesive 118A may be a pressure-sensitive adhesive, a tacky adhesive, etc. The adhesive 118A may be protected by a backing layer 118B that may be peeled off prior to installation. Alternatively, the kit may comprise an adhesive that may be applied onto the contact surface of the elongated trim body 112 or on the receiving surface of the window frame. The illustrated solution of an adhesive 18A pre-applied in plant, for instance with or without a backing layer 118B, is known to be practical.

Referring to FIGS. 9 and 11, the cap is shown at 120, and may have any appropriate shape, including a mushroom cross-section in the manner shown in FIG. 9. Other cross-sectional shapes include a T-shape, a circular shape like the cord 11A (e.g., tubular sealing strip may be used), etc. In the case in which the cap 120 serves as female connector for being connected to the frame member 110, the cap 120 may have a U-shaped cross section. The cap 120 is typically made of a rubbery material, although other more rigid materials may be used as well. The cap 120 comes in an indefinite length, in similar fashion to the frame member 110, so as to be cut to match the length of the frame member segments 110, for instance with the same instrument as used with the frame member 110.

In the embodiment of FIG. 9, the cap 120 has a base portion 121 that is sized to be snugly received in the longitudinal cavity 114 in the manner shown in FIG. 9, so as to be caught therein and removable by manual force. As film 130 will be sandwiched between the base portion 121 of the cap 120 and the surface of the longitudinal cavity 114, or vice versa, the appropriate dimensions should be taken into consideration to ensure that the film 130 is received therein. According to an embodiment, the base portion 121 has a plurality of elongated ribs, to assist in connecting the cap 120 to the frame member 110, and hold the film 130 captive therebetween. Cap 120 may further comprise a bead head 122 that will be the exposed portion of the cap 120 when installed in the manner shown in FIG. 3. The assembly is configured to be flush with the plane of the window frame exterior such that the bead head 122 of the cap 120 has the appearance of a bead molding, for blended architectural appearance. Moreover, the width of the bead head 122 may match that of the frame member 110 for a generally continuous appearance.

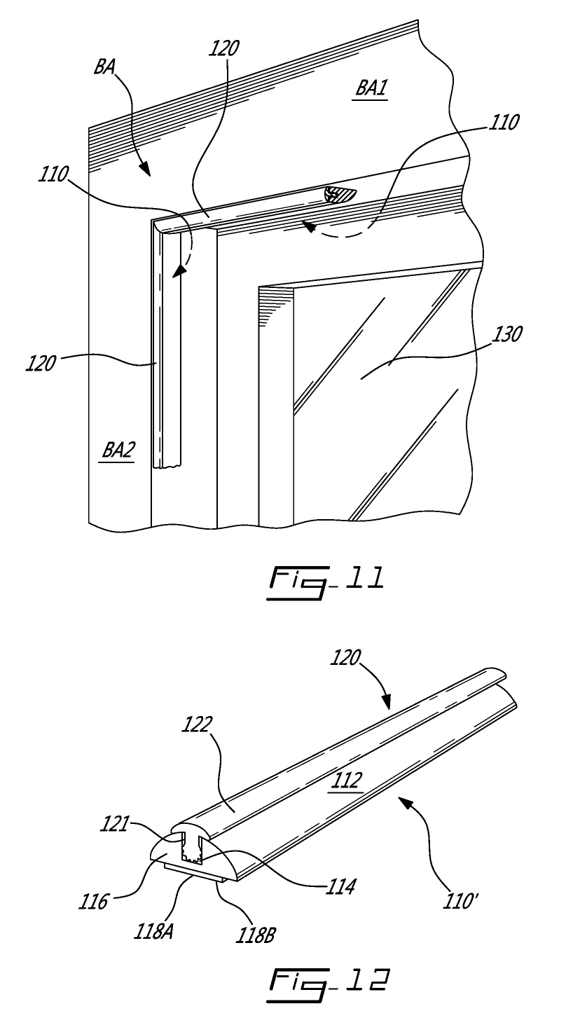

FIGS. 12 to 14 show another embodiment of the window insulating kit, but with the frame members 110′ configured to be mounted to the window frame exterior, in contrast to the embodiment of FIGS. 9-11, in which the frame members 110 are mounted to the window frame interior. Accordingly, like reference numerals will show like elements in FIGS. 9 to 11 and 12 to 14. A notable difference is the shape of the frame member 110′ in the window frame exterior version as observed in FIG. 12. As observed from the end face 116, the frame member 110′ may have a circular segment cross-section shape, although other shapes are considered such as rectangular, square, triangular.

Now that the various components of the window insulating kits have been described, a method of installation is set forth.

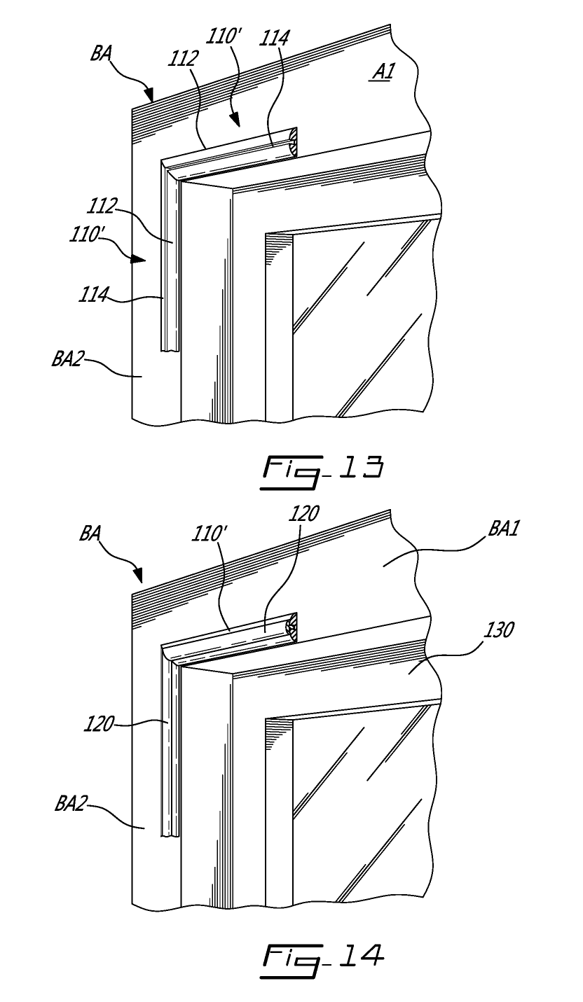

As a first step, the window frame interior/exterior is measured such that a frame member 110/110′ of indefinite length may be cut into segments of appropriate lengths. If the window is rectangular, the segments of the frame members 110/110′ are cut to form 90-degree corners in the manner shown in FIGS. 10 and 13. Once segments of appropriate lengths of the frame member 110/110′ have been cut, the frame members 110/110′ are installed in the window frame interior/exterior to form the frames shown in FIGS. 10 and 11, or FIGS. 13 and 14. It is observed that fragmented frame members 110 are shown in FIGS. 10 and 13 to illustrate the end faces of the frame members. It is however understood that the frame members 110/110′ extend from end to end of the window frame opening. Stated differently, FIGS. 10 and 13 are provided with incomplete frame members 110 for illustrative purposes only.

Once segments of appropriate lengths of the frame member 110 or 110′ have been cut, they may be positioned in the manner shown in FIGS. 10 and 11, or FIGS. 13 and 14. It may be required that the backing layer 118B be peeled off for the adhesive 118A, to be exposed to secure the frame member 110 or 110′ to the surface of the window frame. Alternatively, an adhesive may be applied onto the contact surface of the segments of the frame member 110/110′ or against the window frame receiving surface.

It is required to have segments of the cap 120 of generally similar length as the segments of the frame member 110/110′, whereby the cap 120 may be cut in segments simultaneously with the frame member 110/110′. According to an embodiment, the cap 120 may be assembled in the female-male connection for concurrent section of the frame member 110/110′ and cap 120.

Once a full frame is formed by the frame members 110/110′, the film 130 may be installed. A panel of film 130 of appropriate dimensions is cut. It is expected that the film 130 be cut to a size that exceeds the dimensions of window frame opening, as the cut film 130 may be positioned loosely on the frame of frame members 110/110′. When positioned loosely on the frame of frame members 110/110′, at which point a segment of the cap 120 cut to the appropriate size is pushed into engagement with the frame member 110/110′, with the base portion 121 fitted in the longitudinal cavity 114. In doing so, an edge of the film 130 is held captive therebetween. For practical reasons, it may be desired to start with the top edge of the frame of frame members 110/110′. This step is repeated for the other segments of cap 120 and frame members 110/110′ until the film 130 is surrounded by the caps 120, and held captive by the concurrent action of the frame members 110/110′ and caps 120. At that point, it may be desired to heat the film 130 in order to have it reach a shrinked taut condition. It is also possible to use scissors to remove any excess film on the other side of the cap 120. In doing so, all necessary precautions are taken in order to avoid puncturing the film 130.

As another possibility, if the kit 10 of FIG. 1 is used with cord 11A, the roll 10 is dispensed as the cord 11A is pushed into the longitudinal cavity 114, preferably of the top edge of the frame members 110/110′. Then, once the film 10 is cut, a strip of the length of cord is cut to be received in the longitudinal cavity of the remaining three frame members 110/110′.

When it is required to remove the film 130, for example during the warmers parts of a year in which it is desired to open the window, the various segments of cap 120 may be manually pulled off in order to liberate the film 130 from its engagement with the frame members 110/110′. Alternatively, scissors or a knife may be used to cut the film 30 without removing the cap segments 120. The frame members 110/110′ may remain in place year round. The caps 120 may also remain in the segments of frame member 110/110′ as well in order to preserve the blended architectural appearance. A new film 130 may be added at the next insulating season in order to reinsulate the window by using the already installed frame member 110.

The user therefore derives an advantage from this method, in that the frame members 110 may only need to be installed once for many uses of the window insulating kit. The kit may include indefinite lengths of the frame members 110 or 110′, with an equivalent indefinite length of the cap 120, and with film that may be cut to appropriate dimensions. The kit may also include a cutting tool for sectioning the frame members 110 or 110′ and the cap 120. The kit may also include an adhesive, it not present on the frame members 110 or 110′. As another option, the kit may include pre-cut segments of the frame members 110/110′ as a function of the size of the opening to insulate.

Stated differently, a method for installing the insulating film 130 on the window frame BA comprises securing frame members 110/110′ on the window frame 110 to form a film-receiving frame around an opening of the window frame BA, covering the film-receiving frame of frame members 110/110′ with a panel of the film 130 such that the panel 130 extends over an opening in the window frame BA, and capturing the panel of film 130 by mating a cap 120 with the film-receiving frame 110 all around the opening in the window frame BA. The method may further comprise removing the panel of film 130, and covering the film-receiving frame and opening in the window frame with another panel of the film 130, months later. Accordingly, the frame of frame members 110/110′ is reusable.

While the window insulating kit described above is commonly used for the interior of a dwelling, it is contemplated to use the window insulating kit on the exterior of a dwelling as well. In both cases, the insulating film 130 may be a solar film to assist in blocking or filtering out solar rays. In particular, the insulating film 130 may block out UV radiation, or other parts of the light spectrum, as desired. Regardless of the indoor or outdoor use, the method of installation of the insulating film 130 is generally similar.

1. An insulating film or sheet roll comprising a film or sheet having a pair of longitudinal edges and a pair of lateral edges transverse to the longitudinal edges, an elongated connector extending along one of the longitudinal edges, the insulating film or sheet being rolled about an axis generally parallel to the longitudinal edges starting with the longitudinal edge away from the elongated connector to form an elongated film or sheet, the elongated film or sheet roll being rolled about an axis generally transverse to the longitudinal edges to form the insulating film or sheet roll.

2. The insulating film or sheet roll according to claim 1, wherein the film or sheet has a first face and a second face delimited by the longitudinal edges and the lateral edges, wherein the film or sheet is rolled on its first face when rolled about the axis generally parallel to the longitudinal edges, and wherein the strip of adhesive and the releasable backing strip are on the second face.

3. The insulating film or sheet roll according to claim 1, further comprising a core at the longitudinal edge away from the elongated connector upon which the film or sheet is rolled.

4. The insulating film or sheet roll according to claim 3, wherein the core is a paper, cardboard or polymer flat strip.

5. The insulating film or sheet roll according to claim 3, wherein the longitudinal edge away from the elongated connector is glued to the core.

6. The insulating film or sheet roll according to claim 1, wherein the longitudinal edges are at least three times longer than the lateral edges.

7. The insulating film or sheet roll according to claim 1, wherein the elongated connector includes a strip of adhesive along one of the longitudinal edges, and a releasable backing strip covering the strip of adhesive.

8. An insulating film or sheet kit comprising:
an insulating film or sheet roll comprising a film or sheet having a pair of longitudinal edges and a pair of lateral edges transverse to the longitudinal edges, an elongated connector extending along one of the longitudinal edges, the insulating film or sheet being rolled about an axis generally parallel to the longitudinal edges starting with the longitudinal edge away from the elongated connector to form an elongated film or sheet, the elongated film or sheet roll being rolled about an axis generally transverse to the longitudinal edges to form the insulating film or sheet roll, and
a dispenser having a receptacle for rollingly receiving the insulating film or sheet roll, a dispensing outlet being defined in a wall of the receptacle for a free end of the insulating film or sheet roll to pass therethrough during dispensing.

9. The insulating film or sheet kit according to claim 8, wherein the film or sheet has a first face and a second face delimited by the longitudinal edges and the lateral edges, wherein the film or sheet is rolled on its first face when rolled about the axis generally parallel to the longitudinal edges, and wherein the strip of adhesive and the releasable backing strip are on the second face.

10. The insulating film or sheet kit according to claim 8, further comprising a core at the longitudinal edge away from the elongated connector upon which the film or sheet is rolled.

11. The insulating film or sheet kit according to claim 10, wherein the core is a paper, cardboard or polymer flat strip.

12. The insulating film or sheet kit according to claim 10, wherein the longitudinal edge away from the elongated connector is glued to the core.

13. The insulating film or sheet kit according to claim 8, wherein the longitudinal edges are at least three times longer than the lateral edges.

14. The insulating film or sheet kit according to claim 8, wherein the dispenser has a hub upon which the insulating film or sheet roll is rotationally mounted.

15. The insulating film or sheet kit according to claim 14, further comprising a roll of double-sided tape with backing layer, the hub is hollow, the roll of double-sided tape being received in the hub.

16. The insulating film or sheet kit according to claim 8, further comprising a cover closing the receptacle to hold the insulating film or sheet roll captive in the receptacle.

17. The insulating film or sheet kit according to claim 14, wherein the cover is pivotally connected to the receptacle.

18. The insulating film or sheet kit according to claim 8, wherein the elongated connector includes a strip of adhesive along one of the longitudinal edges, and a releasable backing strip covering the strip of adhesive

19. A method for installing insulating film on a window structure, comprising:
forming an open-ended double-sided tape continuous contour on the window structure;
selecting a length of rolled insulating film corresponding to a distance of an open end of the double-sided tape continuous contour;
removing a backing strip from the length of the rolled insulating film to expose an adhesive strip of the rolled insulating film;
adhering the adhesive strip of the rolled insulating film to the window structure with the adhesive strip closing the open end of the double-sided tape continuous contour;
unrolling the rolled insulating film; and
adhering the insulating film to the double-sided tape continuous contour.
